(19) United States
(12) Patent Application Publication
(10) Pub. No.: US 2012/0152053 A1
(43) Pub. Date: Jun. 21, 2012

(54) PEDAL DEVICE

(75) Inventors: Takuhiro Kondo, Kani-shi (JP); Koji Otake, Sagamihara-shi (JP); Kazutaka Inamitsu, Kani-shi (JP); Yusuke Matsushita, Kani-shi (JP); Ikuhito Ishizue, Kani-shi (JP); Yasuhiro Ota, Kitanagoya-shi (JP); Atsushi Sakuta, Kani-shi (JP); Toshihiro Mori, Kani-shi (JP)

(73) Assignee: KAYABA INDUSTRY CO., LTD., Tokyo (JP)

(21) Appl. No.: 13/393,260

(22) PCT Filed: Aug. 23, 2010
(86) PCT No.: PCT/JP2010/064658

§ 371 Date: Feb. 29, 2012

(30) Foreign Application Priority Data
Sep. 2, 2009 (JP) 2009-202362
Apr. 28, 2010 (JP) 2010-103214

(51) Int. Cl. G05G 1/30

(52) U.S. Cl. 74/513

(57) ABSTRACT

A pedal device is provided with an accelerator pedal pivotally mounted in a vehicle; and a damper disposed between the accelerator pedal and the vehicle. The depressing force as a depression degree of the accelerator pedal is deter mined by the damper according to the movement of the accelerator pedal. Thus, the pedal device does not use friction members which create abrasion and the function thereof is not impaired even if exchange and maintenance are not carried out over a long period of time. Therefore, maintenance frequency and cost of the pedal device can be reduced.

### FIELD OF THE INVENTION

The present invention relates to an improvement in a pedal device.

### BACKGROUND OF THE INVENTION

A conventional pedal device includes, for example, an accelerator pedal pivotally mounted in a vehicle, a return spring disposed between the accelerator pedal and the vehicle for biasing the accelerator pedal to a return position, and a depressing force changer for changing a depressing force (depression degree) of the accelerator pedal.

Specifically, the depressing force changer includes a friction member which is provided on a rotary shaft of the accelerator pedal and a friction member which is made movable toward and away from the former friction member by an actuator mounted in the vehicle. The depressing force changer strongly brings the friction members into contact with each other in the case of increasing the depressing force of the accelerator pedal and, conversely, separates the friction members or reduces a contact surface pressure in the case of reducing the depressing force.

Such a pedal device causes a hysteresis between the depressing force when the accelerator pedal is depressed and the depressing force when the accelerator pedal returns. In this way, the pedal device mitigates fatigue of a driver associated with pedal work and lets the driver easily understand changes in driving characteristics by adjusting the depressing force according to engine rotational speed and vehicle speed (see, for example, JP2005-132225A, JP2004-314871A).

Particularly, a pedal device disclosed in JP2005-132225A lets a driver know about deterioration in fuel economy by increasing a depressing force when a stroke of an accelerator pedal reaches a stroke where fuel consumption is high. The pedal device grasps a stroke, where the amount of fuel consumption is extremely high, in advance from a relationship between a stroke of the accelerator pedal from a return position (i.e. position where an accelerator is off) and engine rotational speed.

### SUMMARY OF THE INVENTION

However, since the conventional pedal device uses the friction members to adjust the depressing force, characteristics of the depressing force may possibly change due to abrasion of the friction members. Further, since the conventional pedal device assumes abrasion, the friction members are forced to be regularly exchanged and maintenance needs to be frequently carried out, thereby causing a problem of requiring time, effort and cost.

Accordingly, an object of the present invention is to provide a pedal device which enables a reduction in maintenance frequency and cost.

To achieve the above object, the present invention is directed to a pedal device, comprising an accelerator pedal pivotally mounted in a vehicle; and a damper disposed between the accelerator pedal and the vehicle.

According to the pedal device of the present invention, when a driver changes a depressing force for depressing the accelerator pedal to change the position of the accelerator pedal, the damper generates the damping force according to a movement of the accelerator pedal. Thus, a sudden movement of the accelerator pedal is suppressed.

Since the damper adjusts the depressing force as a depression degree according to the movement of the accelerator pedal in this way, the pedal device does not use friction members which create abrasion. Thus, the function of the pedal device is not impaired even if exchange and maintenance are not carried out over a long period of time, wherefore maintenance frequency and cost can be reduced.

Further, since the damper generates the damping force for suppressing the movement of the accelerator pedal, the movement of the accelerator pedal becomes slow. Thus, sudden increase and decrease in engine rotational speed can be avoided and the amount of fuel consumption by an engine can be reduced.

The detail, other features and advantages of this invention are described below and shown in the accompanying drawings.

### BRIEF DESCRIPTION OF THE DRAWINGS

FIG. 1 is a schematic diagram of a pedal device according to a first embodiment,

FIG. 2 is a sectional view of a damper in the pedal device of the first embodiment,

FIG. 3 is a schematic diagram of a pedal device according to one modification of the first embodiment,

FIG. 4 is a sectional view of a damper of a pedal device according to another modification of the first embodiment,

FIG. 5 is a sectional view of a damper of a pedal device according to still another modification of the first embodiment,

FIG. 6 is a schematic diagram of a pedal device according to a second embodiment,

FIG. 7 is a sectional view of a damper in the pedal device of the second embodiment,

FIG. 8 is a sectional view of a damper in one modification of the pedal device according to the second embodiment, and

FIG. 9 is a sectional view of a damper in another modification of the pedal device according to the second embodiment.

### DESCRIPTION OF THE PREFERRED EMBODIMENTS

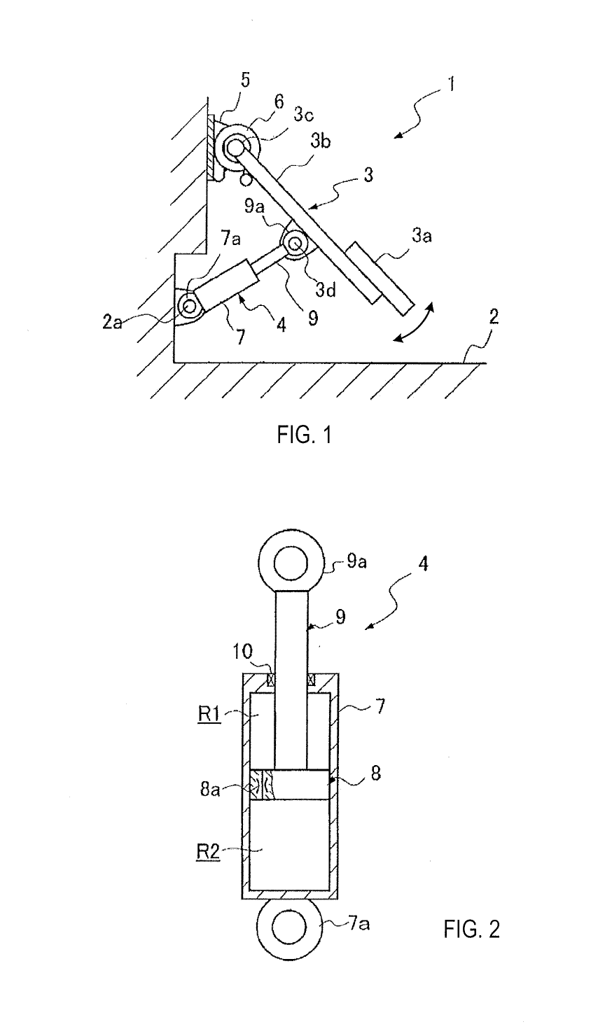

Hereinafter, a pedal device according to a first embodiment is described with reference to the drawings. A pedal device 1 includes, as shown in FIG. 1, an accelerator pedal 3 pivotally mounted in a vehicle 2, and a damper 4 disposed between the accelerator pedal 3 and the vehicle 2.

Respective parts are described in detail below. The accelerator pedal 3 includes a pedal plate 3a to be actually depressed by a driver, a pedal rod 3b attached to the pedal plate 3a, and a shaft 3c attached to the leading end of the pedal rod 3b. The vehicle 2 pivotally supports the shaft 3c and includes a bracket 5. A return spring 6 for returning the pedal plate 3a to an accelerator off position by biasing the pedal plate 3a is disposed between the pedal rod 3b and the bracket 5.

Accordingly, the accelerator pedal 3 can pivot relative to the vehicle 2 in directions of arrows in FIG. 1 with the shaft 3c as a rotary shaft. When not being depressed by the driver, the accelerator pedal 3 returns to the accelerator off position shown in FIG. 1 by a biasing force of the return spring 6. In rotational directions of the accelerator pedal 3, a depressing direction is a direction in which the accelerator pedal 3 rotates when being depressed by the driver. Conversely, a returning direction is a direction in which the accelerator pedal 3 returns to the accelerator off position.

For example, the position of the accelerator pedal 3 is detected by sensing the rotational position of the shaft 3c. An unillustrated controller controls a throttle opening of an unillustrated engine installed in the vehicle 2 based on the detected position of the accelerator pedal 3.

The damper 4 is disposed between the vehicle 2 and the pedal rod 3b and, specifically, rotatably connected to the vehicle 2 and the pedal rod 3. The damper 4 can extend and contract while changing its posture relative to the vehicle 2 and the pedal rod 3 as the accelerator pedal 3 pivots.

Further, as shown in FIG. 2, the damper 4 is of a one-side rod type and includes a cylinder 7, a piston 8 slidably inserted into the cylinder 7 to form two separate operation chambers R1, R2 in the cylinder 7, and a piston rod 9 movably inserted into the cylinder 7 and having one end connected to the piston 8. Gas is filled as fluid in the operation chambers R1, R2. Note that the outer periphery of the piston rod 9 is closely sealed by a seal 10 provided in the cylinder 7 to prevent the fluid from leaking out.

Further, in the first embodiment, the piston 8 is located at an uppermost possible position relative to the cylinder 7 and in a most extended state when the accelerator pedal 3 is at the accelerator off position. This makes the entire length of the telescopic damper 4 maximally short and facilitates mounting into a narrow mounting space by cutting out an unnecessary stroke. Note that the damper 4 in a state where the piston 8 is located at a middle position of the cylinder 7 is shown in FIG. 2 to facilitate description.

The piston 8 is provided with a passage 8a which allows communication between the operation chambers R1 and R2 and gives resistance to the flow of the passing gas. Accordingly, in the damper 4, the gas moves from the compressed operation chamber R1 (R2) to the expanded operation chamber R2 (R1) via the passage 8a when the piston 8 moves relative to the cylinder 7. The passage 8a gives resistance to this gas flow to cause a predetermined pressure loss. A difference is created between pressures in the operation chambers R1, R2 and a damping force which interferes with the movement of the piston 8 is generated.

Specifically, in the damper 4, a ring-shaped bracket 7a provided at an end of the cylinder 7 is rotatably connected to a shaft 2a provided in the vehicle 2 and a ring-shaped bracket 9a provided at the leading end of the piston rod 9 is rotatably connected to a shaft 3d provided on the pedal rod 3b as shown in FIG. 1. This makes extending and contracting directions of the damper 4 coincide with pivoting directions of the accelerator pedal 3. For connection of the damper 4 and the accelerator pedal 3, the piston rod 9 may be connected to a part of the accelerator pedal 3 other than the pedal rod 3b. For example, the cylinder 7 may be connected to the accelerator pedal 3 and the piston rod 9 may be connected to the vehicle 2. Further, the damper 4, the vehicle 2 and the accelerator pedal 3 are rotatably connected so as to be able to rotate in directions not to interfere with the movement of the accelerator pedal 3. Besides connection of the brackets 7a, 9a and the shafts 2a, 3d, it is also possible to use joints capable of connecting the damper 4, the vehicle 2 and the accelerator pedal 3 while allowing the rotation thereof. Such joints are, for example, ball joints, trunnions and crevices.

Thus, when the driver changes the depressing force for depressing the accelerator pedal 3 to change the position of the accelerator pedal 3, the damper 4 generates a damping force according to the movement of the accelerator pedal 3. Thus, a sudden movement of the accelerator pedal 3 is suppressed. The movement of the accelerator pedal 3 becomes slower in response to the damping force generated by the damper 4 to suppress the movement of the accelerator pedal 3. Therefore, sudden increase and decrease in engine rotational speed can be avoided and the amount of fuel consumption by the engine can be reduced.

The depressing force as a depression degree of the accelerator pedal 3 is adjusted by the damper 4 according to the movement of the accelerator pedal 3. Thus, the pedal device does not use friction members which create abrasion and the function thereof is not impaired even if exchange and maintenance are not carried out over a long period of time, wherefore maintenance frequency and cost can be reduced.

In the first embodiment, the gas is so filled in the operation chambers R1, R2 of the damper 4 that the pressures in the operation chambers R1, R2 are not lower than atmospheric pressure in the state where the accelerator pedal 3 is at the accelerator off position. The extending direction of the damper 4 coincides with the returning direction of the accelerator pedal 3.

The damper 4 is of the one-side rod type that the piston rod 9 is inserted only in the operation chamber R1 in addition to filling the gas such that the pressures in the operation chambers R1, R2 are not lower than atmospheric pressure in the state where the accelerator pedal 3 is at the accelerator off position. Accordingly, a pressure receiving area of the piston 8 for receiving the pressure in the operation chamber R2 is larger than that of the piston 8 for receiving the pressure in the operation chamber R1 and, hence, a force constantly acts to extend the piston 8 of the damper 4. Therefore, the damper 4 does not stop a returning movement of the accelerator pedal 3 halfway when the accelerator pedal 3 returns to the accelerator off position.

Further, since the fluid filled in the operation chambers R1, R2 of the damper 4 is the gas, the interior of the vehicle 2 does not get dirty even if the fluid leaks out of the cylinder 7. Further, by using the gas, it is not necessary to provide a reservoir and an air chamber required when the fluid is liquid. In this way, the damper 4 can be miniaturized and ease of mounting into the vehicle can be improved.

On the other hand, if the fluid used in the damper 4 is liquid, an unillustrated reservoir or air chamber for compensating for a volume change in the cylinder equivalent to the volume of the piston rod 9 that moves into and out of the cylinder 7 may be provided.

As described above, a force constantly acts to extend the piston 8 of the damper 4 and the damper 4 constantly generates an extension thrust force. Accordingly, the damper 4 functions as the return spring 6, wherefore the return spring 6 can be omitted. This holds true regardless of whether the fluid used in the damper 4 is gas or liquid.

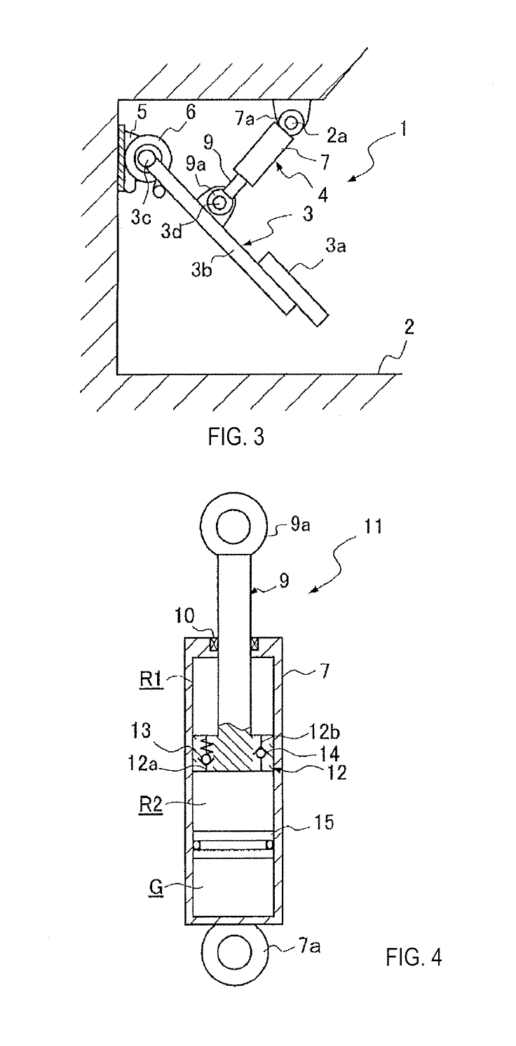

Note that if the function of the return spring 6 is not integrated into the damper 4, the contracting force of the damper 4 may be caused to coincide with the returning direction of the accelerator pedal 3, for example, as shown in FIG. 3. When the contracting force is caused to coincide with the returning direction of the accelerator pedal 3, the damper 4 is in a most contracted state when the accelerator pedal 3 is at the accelerator off position. This can shorten the entire length of the damper 4 and improve ease of mounting of the damper 4 into the vehicle 2.

If the function of the return spring 6 is not integrated into the damper 4, the damper 4 may be of a so-called two-side rod type that the piston rod 9 is inserted in the both operation chambers R1, R2. In this case, the damper 4 generates a thrust force neither when being extended nor when being contracted in a no-load state, wherefore either one of the extending direction and the contracting direction may be caused to coincide with the returning direction of the accelerator pedal 3. Here, that the extending direction of the damper 4 is caused to coincide with the returning direction of the accelerator pedal 3 means that the accelerator pedal 3 moves in the returning direction when the damper 4 extends. An actual axis line in the extending direction of the damper 4 and that in the returning direction of the accelerator pedal 3 need not perfectly coincide. Links or other devices may be provided between the damper 4 and the accelerator pedal 3 and between the damper 4 and the vehicle 2. For example, the other device is a device for transmitting a motion of the damper 4 to the accelerator pedal 3 while decelerating or accelerating it.

As described above, the accelerator pedal 3 is a so-called hanging type accelerator pedal in which the accelerator pedal 3 is hung down from an upper side by the pedal rod 3b. However, in the case of using a so-called organ type accelerator pedal in which the pedal rod 3b is omitted and the bottom end of the pedal plate 3a is pivotally mounted in the vehicle 2, the damper 4 is disposed between the pedal plate 3a and the vehicle 2. This similarly holds true for respective embodiments of pedal devices using the same telescopic damper as the damper 4 described later.

As a modification of the pedal device of the first embodiment, a one-way damper 11 which generates no damping force for the rotation of the accelerator pedal 3 in the returning direction may be used as shown in FIG. 4.

Unlike the damper 4, the damper 11 includes a piston 12 provided with two passages 12a, 12b as shown in FIG. 4. A damping valve 13 is provided at an exit end of one passage 12a, and a check valve 14 is provided at an exit end of the other passage 12b. Further, unlike the damper 4, the damper 11 includes a free piston 15 slidably inserted into a cylinder 7. Gas is filled in an air chamber G formed in the cylinder 7 by the free piston 15, and liquid is filled as fluid in operation chambers R1, R2. Note that the constructions of the other parts in the damper 11 are similar to those of the damper 4. The constructions similar to the damper 4 are denoted by the same reference numerals and not described in detail to avoid repeated description.

In the damper 11, the passage 12a is made one way by the damping valve 13 and allows only the flow of the fluid from the operation chamber R2 to the operation chamber R1 where the piston rod 9 is inserted. The damping valve 13 gives resistance to the flow of the passing fluid. On the other hand, the passage 12b is made one way by the check valve 14 and allows only the flow of the fluid from the operation chamber R1 where the piston rod 9 is inserted to the operation chamber R2. The check valve 14 gives almost no resistance to the flow of the passing fluid.

In the damper 11, an increase or decrease in the total volume of the operation chambers R1, R2 caused by a movement of the piston rod 9 in the cylinder 7 is compensated for by enlarging or reducing the air chamber G through a displacement of the free piston 15 relative to the cylinder 7.

In this case, similar to the damper 4, the damper 11 is disposed between the accelerator pedal 3 and the vehicle 2 with an extending direction thereof caused to coincide with the returning direction of the accelerator pedal 3.

Accordingly, by pressurizing the interiors of the operation chambers R1, R2 by a pressure in the air chamber G, the accelerator pedal 3 can be biased in the returning direction by the damper 11. Thus, the return spring 6 can be omitted also in this modification.

For example, various liquids such as oil, water and aqueous solution can be used as the liquid filled in the operation chambers R1, R2.

In the damper 11, the check valve 14 is not opened and only the passage 12a is open to give resistance by the damping valve 13 for the flow of the liquid from the operation chamber R2 to the operation chamber R1. On the other hand, the check valve 14 opens the passage 12b for the flow of the liquid from the operation chamber R1 to the operation chamber R2 and allows this flow while giving almost no resistance. Thus, the damper 11 generates a damping force during contraction while generating almost no damping force during extension.

Accordingly, depression becomes heavier due to the damping force generated by the damper 11 for a movement of the accelerator pedal 3 in the depressing direction and, conversely, the damper 11 generates no damping force for a movement of the accelerator pedal 3 in the returning direction and depression becomes lighter.

Thus, the depressing force can be increased for the operation of the accelerator pedal 3 in a direction to increase the amount of fuel consumption. Further, since the return of the accelerator pedal 3 is not interfered with, fuel consumption can be more effectively reduced.

The damper 11 adjusts the depressing force as the depression degree according to the movement of the accelerator pedal 3. Thus, the damper 11 does not use friction members which create abrasion and the function thereof is not impaired even if exchange and maintenance are not carried out over a long period of time. Therefore, similar to the above damper 4, maintenance frequency and cost of the damper 11 can be reduced.

Note that the damper 11 generates the damping force during contraction and generates almost no damping force during extension as described above. However, if the directions of the damping valve 13 and the check valve 14 are reversed on the contrary, the damper 11 generates the damping force during extension and generates almost no damping force during depression. In this case, the returning direction of the accelerator pedal 3 and the contracting direction of the damper coincide.

If the damping valve 13 is an orifice, the depressing force is generated in proportion to the square of piston speed. In this case, a very large depressing force is generated for sudden contraction of the damper 11 and, on the other hand, a very small depressing force is generated for slow contraction of the damper 11. Thus, it is possible to increase the depressing force for a sudden movement of the accelerator pedal 3 in the depressing direction and decrease the depressing force for a slow movement of the accelerator pedal 3 in the depressing direction. Therefore, driving that increases the amount of fuel consumption can be known to a driver by an increase in the depressing force. Further, by letting the driver sense an accelerator pedal operation with high fuel consumption, the accelerator pedal operation of the driver can be corrected to reduce the amount of fuel consumption.

If the damping valve 13 is composed only of an orifice, the damping force of the damper 11 may become excessive for sudden depression of the accelerator pedal 3 in dependence on an orifice opening. In this case, a relief valve may be provided in parallel with the orifice. Specifically, the relief valve may be a leaf valve which opens and closes the exit end of the passage 12a and the orifice may be provided on the outer periphery of the leaf valve or the piston 12. Further, as a matter of course, an orifice can be provided in the passage 8a of the damper 4 described above.

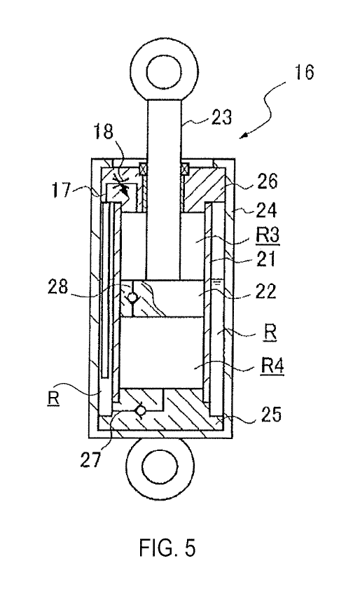

A damping valve provided in a passage may be a variable damping valve. Specifically, a variable damping valve 18 is provided at an intermediate position of a passage 17 which allows communication between an operation chamber R3 and a reservoir R in a damper 16, for example, as shown in FIG. 5.

The damper 16 includes a cylinder 21, a piston 22, a piston rod 23, an outer tube 24, a partition member 25, a rod guide 26, the passage 17, a one-way passage 27 and a one-way passage 28. The piston 22 is slidably inserted into the cylinder 21, whereby the operation chamber R3 in which the piston rod 23 is inserted and an operation chamber R4 where the piston rod 23 is not inserted are separately formed in the cylinder 21. The piston rod 23 is movably inserted into the cylinder 21 and has one end connected to the piston 22. The outer tube 24 covers the outer periphery of the cylinder 21 and for ms the reservoir R between the outer tube 24 and the cylinder 21. The partition member 25 is disposed between the cylinder 21 and the outer tube 24 to partition the reservoir R and the operation chamber R4. The rod guide 26 is ring-shaped, closes one ends of the cylinder 21 and the outer tube 24 and slidably supports the piston rod 23. The passage 17 is provided in the rod guide 26 and allows communication between the operation chamber R3 and the reservoir R. The one-way passage 27 is provided in the partition member 25 and allows only the flow of fluid from the reservoir R to the operation chamber R4. The one-way passage 28 is provided in the piston 22 and allows only the flow of fluid from the operation chamber R4 to the operation chamber R3.

When the damper 16 is extended, the fluid in the operation chamber R3 moves to the reservoir R via the passage 17 and the fluid is supplied from the reservoir R to the operation chamber R4 being expanded via the one-way passage 27. On the contrary, when the damper 16 is contracted, the fluid in the operation chamber R4 being compressed flows into the operation chamber R3 via the one-way passage 28 since the one-way passage 27 prevents the fluid from moving to the reservoir R. The amount of the fluid equivalent to the volume of a part of the piston rod 23 entering the cylinder 21 becomes excessive in the operation chamber R3 and moves to the reservoir R via the passage 17.

The damper 16 is of a uniflow type in which the fluid is circulated one way in the order of the pressure chamber R3, the pressure chamber R4 and the reservoir R. The damper 16 generates a damping force by giving resistance to the flow of the fluid passing through the passage 17 by the variable damping valve 18 at the time of extension and contraction. Note that if the cross-sectional area of the piston rod 23 is set to be half that of the piston 22, the flow rates of the fluid passing through the passage 17 at the time of extension and contraction of the damper 16 are equal. In this case, if resistance in the variable damping valve 18 is set to be equal at the time of extension and contraction, the damping force generated by the damper 16 can be made substantially equal at the time of extension and contraction.

As just described, the damper may be of the uniflow type like the damper 16 and the dampers 4, 11 described above may also adopt a uniflow type construction. Also in the damper 16, the variable damping valve 18 may be provided in the passages 8a, 12a that allow communication between the operation chambers R1 and R2 by adopting a construction like those of the dampers 4, 11. Note that since the fluid moves in one direction in the uniflow type damper 16, the damping force of the damper 16 is generated with good responsiveness and a driver does not feel any sense of incongruity.

The variable damping valve 18 includes, for example, a solenoid, a valve element driven by the solenoid and a valve seat provided at an intermediate position of the passage 17 although not shown in detail. The solenoid can adjust resistance given to the flow of the fluid passing through the variable damping valve 18 by applying a thrust force generated thereby to the valve element to make a flow path area variable or change a valve opening pressure.

The construction of the variable damping valve 18 is arbitrary and the valve element may be driven via a feed screw mechanism using a motor besides being driven by the solenoid. Further, if the variable damping valve 18 is a rotary valve, a valve element may be driven by a stepping motor. The rotary valve includes a valve element which is tubular and has a through hole at its lateral part, and a housing (in many cases, hollow piston rod) which houses the valve element and has a hole, which can face the through hole of the valve element. The rotary valve adjusts a flow path area according to an overlapping degree of the through hole of the valve hole and the hole of the housing. In this way, a drive source suitable for the structure of the valve element can be adopted.

The variable damping valve 18 is, for example, under the control of an unillustrated controller. The controller calculates a damping force to be generated by the damper 16 in response to an accelerator pedal operation, causes the damper 16 to generate the damping force as calculated, and adjusts the depressing force as the depression degree of the accelerator pedal 3. Further, the controller may adjust the depression degree of the accelerator pedal 3 based on driving conditions such as engine rotational speed and vehicle speed in addition to the accelerator pedal operation.

The damper 16 may include the variable damping valve 18 and adjust the damping force. Accordingly, the depressing force of the accelerator pedal 3 can be changed according to the accelerator pedal operation or driving conditions. Thus, in the case of such an accelerator pedal operation or driving conditions as to increase the amount of fuel consumption, driving that increases the amount of fuel consumption can be known to a driver by increasing the depressing force of the accelerator pedal 3. Further, by letting the driver sense an accelerator pedal operation with high fuel consumption, the accelerator pedal operation of the driver can be corrected to reduce the amount of fuel consumption.

Note that since the return of the accelerator pedal 3 is not interfered with at least when the flow path area of the variable damping valve 18 is maximized and the damper 16 minimizes the damping force for the rotation of the accelerator pedal 3 in the returning direction, fuel consumption can be more effectively reduced. Further, in the case of an accelerator pedal operation or driving conditions not leading to an increase in the amount of fuel consumption, the depressing force of the accelerator pedal 3 may be reduced in both the depressing direction and the returning direction of the accelerator pedal 3. In this case, an effect of reducing the amount of fuel consumption can be obtained without the accelerator pedal operation of the driver being interrupted.

In such a case where the vehicle is running at a constant speed and the accelerator pedal 3 is maintained at a fixed position, the flow path area of the passage 17 may be reduced by the variable damping valve 18. In this case, it is difficult for the damper 16 to extend and contract and the depressing force given by the driver to maintain the accelerator pedal 3 at the fixed position can also be reduced.

Further, if the passage 17 can be completely closed by the variable damping valve 18, the depressing force given by the driver to maintain the accelerator pedal 3 at the fixed position can be further reduced by preventing extension and contraction of the damper 16. If a detector for detecting theft of the vehicle is provided, the damper 16 is made inextensible and incompressible when theft is detected. In this way, the accelerator pedal 3 is locked at the accelerator off position and the accelerator pedal cannot be operated, whereby theft can be prevented.

Since the damper 16 adjusts the depressing force as the depression degree according to the movement of the accelerator pedal 3, friction members which create abrasion are not used in the pedal device. Accordingly, the function of the pedal device is not impaired even if exchange and maintenance are not carried out over a long period of time, wherefore maintenance frequency and cost can be reduced similar to the above damper 4.

As described above, since the damping valve is a variable damping valve, the damping force of the damper is adjusted. If the fluid is electrorheological fluid, a voltage, the magnitude of which can be changed, may be applied to the passage instead of providing the variable damping valve in the passage of each of the dampers 4, 11 and 16. Further, if the fluid is magnetorheological fluid, the damping force may be adjusted by applying a magnetic field, the magnitude of which can be changed, to the passage instead of providing the variable damping valve in the passage of each of the dampers 4, 11 and 16.

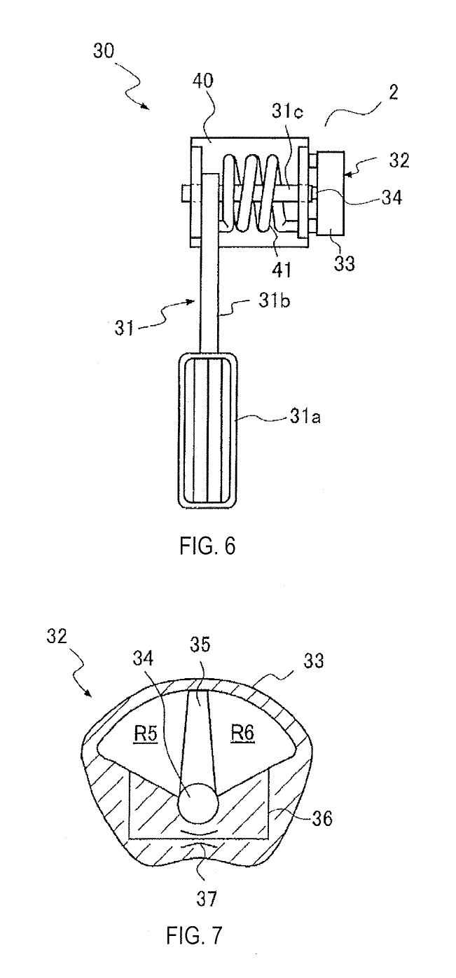

Further, a pedal device 30 according to a second embodiment is described. As shown in FIGS. 6 and 7, the pedal device 30 includes an accelerator pedal 31 pivotally connected to a vehicle 2 and a damper 32 connected to the vehicle 2 and the accelerator pedal 31.

Respective parts are described in detail below. The accelerator pedal 31 includes a pedal plate 31a to be actually depressed by a driver, a pedal rod 31b attached to the pedal plate 31a, and a shaft 31c attached to the leading end of the pedal rod 31b. The vehicle 2 includes a bracket 40 for rotatably supporting the shaft 31c. A return spring 41 for returning the pedal plate 31a to an accelerator off position by biasing the pedal plate 31a is disposed between the pedal rod 31b and the bracket 40.

Similar to the dampers 4, 11 and 16, the damper 32 is connected to the vehicle 2 and the accelerator pedal 31 and can adjust a depression degree of the accelerator pedal 31 by generating a damping force suitable for a movement of the accelerator pedal 31.

The damper 32 includes a container 33, a rotary shaft 34, a vane 35, a passage 36 and a damping valve 37. The container 33 is attached to the vehicle 2. The rotary shaft 34 is connected to the shaft 31c and rotatably inserted into the container 33. The vane 35 is attached to the rotary shaft 34 and rotatably inserted into the container 33, thereby forming two separate operation chambers R5, R6, in which fluid is sealed, in the container 33. The passage 36 allows communication between the operation chambers R5 and R6. The damping valve 37 is disposed at an intermediate position of the passage 36. Note that the container 33 is mounted in the vehicle 2 via the bracket 40 fixed to the vehicle 2 in this case.

In the damper 32, the rotary shaft 34 rotates and the vane 35 compresses one operation chamber R5 (R6) and expands the other operation chamber R6 (R5). At this time, the damping valve 37 gives resistance to the flow of the fluid passing in the passage 36, whereby a pressure difference is created between the operation chambers R5 and R6 to generate a damping force for suppressing the rotation of the rotary shaft 34. Note that although not shown, an accumulator for compensating for a volume change caused by a temperature change of the fluid is disposed in the operation chamber R5, R6 or the passage 36.

The shaft 31c is connected to the rotary shaft 34, and the rotation thereof is also suppressed by the damping force. Thus, when the driver changes the depressing force for depressing the accelerator pedal 31 to change the position of the accelerator pedal 31, the damper 32 generates the damping force according to the movement of the accelerator pedal 31, wherefore a sudden movement of the accelerator pedal 31 is suppressed. Then, the movement of the accelerator pedal 31 becomes slower in response to the damping force generated by the damper 32 to suppress the movement of the accelerator pedal 31. Therefore, sudden increase and decrease in engine rotational speed can be avoided and the amount of fuel consumption by an engine can be reduced.

Since the damper 32 adjusts the depressing force as the depression degree of the accelerator pedal 31 according to the movement of the accelerator pedal 31, friction members which create abrasion are not used. Since the function of the damper 32 is not impaired even if exchange and maintenance are not carried out over a long period of time, maintenance frequency and cost of the pedal device can be reduced.

Since the damper 32 is of a so-called rotary type and can be directly attached to the shaft 31c as a rotary shaft of the accelerator pedal 31, the entire pedal device can be miniaturized. Note that although the rotary shaft 34 is connected to the shaft 31c in the second embodiment, the container 33 may be connected to the shaft 31c and the rotary shaft 34 may be connected to the vehicle 2 or they may be connected via links or the like.

The damper 32 may be a one-way damper including a plurality of passages, wherein a damping valve is disposed only in one passage and a check valve is disposed in the other passage. In this case, since the damper 32 suppresses a sudden movement only for a depressing operation of the accelerator pedal similar to the damper 11, the amount of fuel consumption by the engine can be effectively reduced.

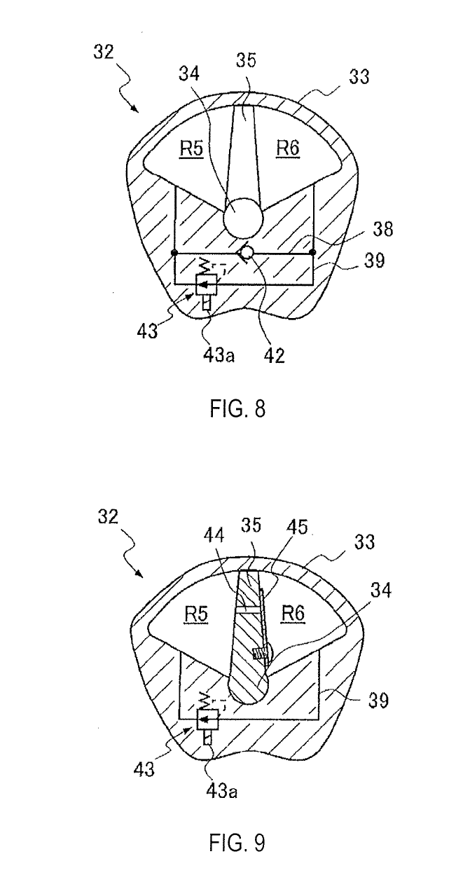

Specifically, as shown in FIG. 8, passages 38, 39 which allow communication between the operation chambers R5 and R6 in the damper 32 are provided. The damper 32 includes a check valve 42 in the passage 38 for allowing only the flow of fluid from the operation chamber R5 to the operation chamber R6 and a damping valve 43 in the passage 39. The damper 32 is so mounted that the operation chamber R5 is compressed and the operation chamber R6 is expanded when the accelerator pedal 31 rotates to return and the operation chamber R6 is compressed and the operation chamber R5 is expanded when the accelerator pedal 31 is depressed to rotate. In this way, the fluid moves from the compressed operation chamber R6 to the expanded operation chamber R5 when the accelerator pedal 31 is depressed. Since the check valve 42 in the passage 38 is kept closed, the fluid moves via the damping valve 43. In this case, the damper 32 generates the damping force for the depression of the accelerator pedal 31. Contrary to this, when the accelerator pedal 31 rotates in the returning direction, the fluid moves from the compressed operation chamber R5 to the expanded operation chamber R6. Since the check valve 42 in the passage 38 is opened, the fluid moves via the passage 38. In this case, the damper 32 generates almost no damping force for the return of the accelerator pedal 31. Thus, the amount of fuel consumption by the engine can be effectively reduced by suppressing a sudden movement only for the depressing operation of the accelerator pedal.

Note that if the damping valve 43 is an electromagnetic valve driven by a solenoid 43a as shown in FIG. 8, resistance given to the flow of the fluid can be adjusted. Accordingly, in this case, the amount of the accelerator pedal operation of the driver can be corrected to effectively reduce the amount of fuel consumption by adjusting the depressing force for the operation of the accelerator pedal 31 and letting the driver sense an accelerator pedal operation with high fuel consumption.

Further, as shown in FIG. 9, the damper 32 may be such that the vane 35 includes a through hole 44 which allows communication between the operation chambers R5 and R6 and functions as the above described passage 38 and a flexible and tongue-like check valve 45 which is laminated on a surface of the vane 35 facing the operation chamber R6 and opens and closes the through hole 44. The base end of this check valve 45 is fixed to the vane 35 and the leading end thereof is a free end. The check valve 45 closes the through hole 44 while being held in contact with the surface of the vane 35 facing the operation chamber R6, and opens the through hole 44 when the leading end thereof is deflected to move away from the surface of the vane 35 facing the operation chamber R6. The damper 32 is so mounted that the operation chamber R5 is compressed and the operation chamber R6 is expanded when the accelerator pedal 31 rotates to return and the operation chamber R6 is compressed and the operation chamber R5 is expanded when the accelerator pedal 31 is depressed to rotate.

That is, the check valve 45 is laminated on the surface facing the operating chamber R6 expanded when the accelerator pedal 31 rotates to return. When the accelerator pedal 31 rotates to return, the check valve 45 is deflected to open the through hole 44, whereby the fluid can move from the compressed operation chamber R5 to the expanded operation chamber R6. In this case, since the fluid moves via the through hole 44 in preference to the passage 39 where the damping valve 43 is disposed, the damper 32 generates almost no damping force for the return of the accelerator pedal 31. On the contrary, when the accelerator pedal 31 is depressed, the fluid moves from the compressed operation chamber R6 to the expanded operation chamber R5 and the check valve 45 is pressed against the vane 35 to close the through hole 44 in response to a pressure from the operation chamber R6. In this case, the fluid moves via the damping valve 43 and the damper 32 generates the damping force for the depression of the accelerator pedal 31.

By providing the vane 35 with the through hole 44 and constructing the check valve 45 as described above, the damper 32 is miniaturized and ease of mounting into the vehicle is improved. Further, since the check valve 45 has a simple construction of disposing a tongue-like valve on the vane 35 and is easily exchanged, characteristics of the damper 32 can be easily changed.

Further, since the fluid moves in one direction in the damper 32, the damping force of the damper 32 is generated with good responsiveness and the driver does not feel any sense of incongruity.

If the fluid is electrorheological fluid or magnetorheological fluid and the damping force to be generated can be adjusted, the damper 32 has functions and effects similar to those of the pedal device including the damper 16.

Note that the passages may be provided outside the cylinder or the container besides in the piston, the vane and the piston rod in the respective dampers described above. The telescopic damper may be of a ram-type if a reservoir is provided outside the cylinder besides being of the one-side rod type and two-side rod type.

It is apparent that the present invention is not limited to the above embodiments, various modifications and changes can be made within the scope of the technical idea thereof and such are also embraced by the technical scope of the present invention.

All the contents of Japanese Patent Application No. 2009-202362 filed on Sep. 2, 2009 and Patent Application No. 2010-103214 filed on Apr. 28, 2010 are hereby incorporated by reference.

### INDUSTRIAL APPLICABILITY

The present invention is applicable to pedal devices.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (cancelled)

16. (cancelled)

17. A pedal device, comprising:
an accelerator pedal pivotally mounted in a vehicle; and
a damper disposed between the accelerator pedal and the vehicle,
wherein the damper generates a larger damping force in a depressing direction than in a returning direction of the accelerator pedal.

18. The pedal device according to claim 17, wherein the damper generates a damping force when the accelerator pedal pivots and can adjust the generating damping force.

19. The pedal device according to claim 18, wherein the damping force of the damper is minimized for rotation of the accelerator pedal in a returning direction.

20. The pedal device according to claim 17, wherein the damper is a one-way damper which generates no damping force for rotation of the accelerator pedal in a returning direction.

21. The pedal device according to claim 17, wherein the damper comprises:
a cylinder rotatably connected to one of the vehicle and the accelerator pedal;
a piston slidably inserted into the cylinder to form two separate operation chambers, in which fluid is sealed, in the cylinder; and
a piston rod movably inserted into the cylinder and having one end connected to the piston and the other end rotatably connected to the other of the vehicle and the accelerator pedal.

22. The pedal device according to claim 21, wherein:
the damper is a one-side rod type damper in which the piston rod is inserted only in either one of the operation chambers; and
the damper is such that an extending direction is a returning direction of the accelerator pedal and pressures in the operation chambers are set to be not lower than atmospheric pressure at least when the accelerator pedal is at a position where an accelerator is off.

23. The pedal device according to claim 17, wherein:
the accelerator pedal is mounted in the vehicle via a shaft rotatably supported on the vehicle; and
the damper includes a container connected to one of the vehicle and the shaft and a vane rotatably inserted into the container to form two separate operation chambers, in which fluid is sealed, in the container and connected to the other of the vehicle and the shaft.

24. The pedal device according to claim 21, wherein the damper includes an orifice which allows communication between the respective operation chambers.

25. The pedal device according to claim 23, wherein the damper includes an orifice which allows communication between the respective operation chambers.

26. The pedal device according to claim 21, wherein the damper includes operation chambers in which electrorheological fluid is filled, and a passage which allows communication between the respective operation chambers and can apply a voltage to the passing electrorheological fluid.

27. The pedal device according to claim 23, wherein the damper includes operation chambers in which electrorheological fluid is filled, and a passage which allows communication between the respective operation chambers and can apply a voltage to the passing electrorheological fluid.

28. The pedal device according to claim 21, wherein the damper includes operation chambers in which magnetorheological fluid is filled, and a passage which allows communication between the respective operation chambers and can apply a magnetic field to the passing magnetorheological fluid.

29. The pedal device according to claim 23, wherein the damper includes operation chambers in which magnetorheological fluid is filled, and a passage which allows communication between the respective operation chambers and can apply a magnetic field to the passing magnetorheological fluid.

30. The pedal device according to claim 21, wherein the damper is such that the fluid in the form of gas is filled in the operation chambers.

31. The pedal device according to claim 23, wherein the damper is such that the fluid in the form of gas is filled in the operation chambers.

32. The pedal device according to claim 21, wherein:
the damper includes a first passage which allows only the flow of the fluid from the compressed operation chamber to the expanded operation chamber when the accelerator pedal rotates in the returning direction and a second passage which allows only the flow of the fluid from the compressed operation chamber to the expanded operation chamber when the accelerator pedal rotates in a depressing direction; and
a damping valve is provided only in the second passage, out of the passages, in which the fluid flows when the accelerator pedal rotates in the depressing direction.

33. The pedal device according to claim 23, wherein:
the damper includes a first passage which allows only the flow of the fluid from the compressed operation chamber to the expanded operation chamber when the accelerator pedal rotates in the returning direction and a second passage which allows only the flow of the fluid from the compressed operation chamber to the expanded operation chamber when the accelerator pedal rotates in a depressing direction; and
a damping valve is provided only in the second passage, out of the passages, in which the fluid flows when the accelerator pedal rotates in the depressing direction.

34. The pedal device according to claim 23, wherein the damper comprises:
a through hole which is provided in the vane and allows communication between the operation chambers;
a check valve which opens and closes the through hole and allows only the flow of the fluid from the compressed operation chamber to the expanded operation chamber when the accelerator pedal rotates in the returning direction;
a passage which allows communication between the operation chambers; and
a damping valve which is disposed at an intermediate position of the passage and allows only the flow of the fluid from the compressed operation chamber to the expanded operation chamber when the accelerator pedal rotates in the depressing direction.

35. The pedal device according to claim 34, wherein the check valve is flexible and tongue-like and opens and closes the through hole by being laminated on a surface of the vane facing the operation chamber expanded when the accelerator pedal rotates in the returning direction.

36. The pedal device according to claim 32, wherein the damping valve can adjust resistance given to the flow of the fluid.

37. The pedal device according to claim 33, wherein the damping valve can adjust resistance given to the flow of the fluid.

38. The pedal device according to claim 34, wherein the damping valve can adjust resistance given to the flow of the fluid.
